(19) United States
(12) Patent Application Publication
(10) Pub. No.: US 2011/0213055 A1
(43) Pub. Date: Sep. 1, 2011

(54) COPOLYESTERS WITH ENHANCED TEAR STRENGTH

(75) Inventors: Rameshchandra m. Gohil, Newark, DE (US); Noel M. Hasty, Wilmington, DE (US); Edward J. Stancik, Wilmington, DE (US); Mark F. Teasley, Landenberg, PA (US)

(73) Assignee: E.I. DU PONT DE NEMOURS AND COMPANY, Wilmington, DE (US)

(21) Appl. No.: 13/127,060

(22) PCT Filed: Dec. 14, 2009
(86) PCT No.: PCT/US09/67838

§ 371 Date: May 2, 2011

Related U.S. Application Data
(62) Division of application No. 61/122,500, filed on Dec. 15, 2008.
Application No. 61/122,500 is a division of application No. 61/262,683, filed on Nov. 19, 2009.

(51) Int. Cl. C08L 67/02; C08G 63/672; C08G 63/181; C08L 3/02

(52) U.S. Cl. 524/47; 528/301; 528/302; 525/448

(57) ABSTRACT

This invention relates to aliphatic-aromatic copolyesters that can exhibit improved tear strength and improved rate of biodegradation. Particularly to an aliphatic-aromatic copolyester having a dicarboxylic acid component and a glycol component. The invention also relates to articles and blends using the copolyesters.

### FIELD OF THE INVENTION

This invention relates to aliphatic-aromatic copolyesters that can exhibit improved tear strength and improved rate of biodegradation. The invention also relates to articles and blends using the copolyesters.

### BACKGROUND

As population increases, resources become scarce and societal habits have a greater impact on our environment. Awareness of these facts has led to a movement in sustainability, in which energy sources, carbon footprint, and land use all play a role. In an ideal world, the materials that we use would be made from renewable materials using renewable energy and would degrade harmlessly back into their original form shortly after they serve their purpose. The intent of this invention is to take a step in that direction by overcoming some of the shortcomings that have plagued previous efforts to develop such materials.

Such previous efforts have focused on two broad areas, aliphatic polyesters and copolyesters, and aliphatic-aromatic copolyesters. Aliphatic polyesters are generally synthesized by reaction of a single diol with one or more linear aliphatic dicarboxylic acids. Despite showing significant biodegradation potential, their thermal properties are often insufficient for real world applications. Specifically, the homopolymers often have low melt temperatures and the copolymers often have low crystallinity or are amorphous.

Because of these shortcomings, a greater body of work focuses on aliphatic-aromatic copolyesters. Generally, these are synthesized by reaction of a single diol with a linear aliphatic dicarboxylic acid and an aromatic dicarboxylic acid, typically terephthalic acid. See for example, Witt, U. et al., J. Environ. Polym. Degr. 1995, 3(4), pp 215-223.

Aliphatic-aromatic copolyesters that include a fourth or even more monomers are not discussed as frequently. Armstrong World Industries, Inc., in U.S. Pat. Appl. No. 20080081898, discloses fibers composed of such mixtures. Specifically, the use of mixtures of diols, mixtures of 6 or more monomers, significant fractions of trifunctional molecules, and cycloaliphatic molecules are illustrated in the application.

Herein are disclosed aliphatic-aromatic copolyesters that comprise a more limited mixture of monomers. These compositions provide films that show an improvement in tear strength relative to those described in the wider body of work on aliphatic-aromatic copolyesters. At the same time, these compositions provide thermal and biodegradation properties that make them particularly useful for flexible films applications.

### SUMMARY OF THE INVENTION

The present invention relates to an aliphatic-aromatic copolyester consisting essentially of:

I. a dicarboxylic acid component consisting essentially of, based on 100 mole percent total acid component:
a. about 40 to 80 mole percent of a first aromatic dicarboxylic acid component consisting essentially of a terephthalic acid component; and
b. about 60 to 10 mole percent of a linear aliphatic dicarboxylic acid component; and
c. about 2 to 30 mole percent of second aromatic dicarboxylic acid component; and

II. a glycol component consisting essentially of, based on 100 mole percent total glycol component:
a. about 100 to 96 mole percent of a linear glycol component; and
b. about 0 to 4 mole percent of a dialkylene glycol component.

The invention further relates to blends of said aliphatic-aromatic copolyesters with other polymeric materials, including natural substances. It also relates to shaped articles comprising said aliphatic-aromatic copolyesters and their blends.

### DETAILED DESCRIPTION

Herein are described aliphatic-aromatic copolyesters that can be processed into films with enhanced tear strength. The copolyesters are typically semicrystalline and biodegradable, and their films are typically compostable. The copolyesters are prepared via the polymerization of a glycol component with terephthalic acid as a first dicarboxylic acid component, a linear aliphatic dicarboxylic acid component, and a second aromatic dicarboxylic acid component. Note that the esters, anhydrides, or ester-forming derivatives of the acids may be used. The terms “glycol” and “diol” are used interchangeably to refer to general compositions of a primary, secondary, or tertiary alcohol containing two hydroxyl groups. The term “semicrystalline” is intended to indicate that some fraction of the polymer chains of the aromatic-aliphatic copolyesters reside in a crystalline phase with the remaining fraction of the polymer chains residing in a non-ordered glassy amorphous phase. The crystalline phase is characterized by a melting temperature, Tm, and the amorphous phase by a glass transition temperature, Tg, which can be measured using Differential Scanning calorimetry (DSC).

Generally, the acid component will comprise between about 80 and 40 mole percent of a terephthalic acid component based on 100 mole percent total acid component, between about 10 and 60 mole percent of a linear aliphatic dicarboxylic acid component based on 100 mole percent of total acid component, and between about 2 and 30 mole percent of a second aromatic dicarboxylic acid component based on 100 mole percent of total acid component. Additionally, the glycol component consists essentially of about 100 to 96 mole percent of a linear glycol component based on 100 mole percent total glycol component, and about 0 to 4 mole percent of a dialkylene glycol component based on 100 mole percent total glycol component.

Typically, the acid component will comprise between about 69 and 46 mole percent of a terephthalic acid component based on 100 mole percent total acid component, between about 26 and 49 mole percent of a linear aliphatic dicarboxylic acid component based on 100 mole percent of total acid component, and between about 4 and 19 mole percent of a second aromatic dicarboxylic acid component based on 100 mole percent of total acid component.

Often, the acid component will comprise between about 59 and 51 mole percent of a terephthalic acid component based on 100 mole percent total acid component, between about 34 and 44 mole percent of a linear aliphatic dicarboxylic acid component based on 100 mole percent of total acid component, and between about 6 and 14 mole percent of a second aromatic dicarboxylic acid component based on 100 mole percent of total acid component.

Generally, the ratio of the mole percent of the second aromatic dicarboxylic acid to terephthalic acid is less than about 3:4. More typically, the ratio of the mole percent of the second aromatic dicarboxylic acid to terephthalic acid is less than about 19:46. Often, the ratio of the mole percent of the second aromatic dicarboxylic acid to terephthalic acid is less than about 14:51. In some embodiments, the ratio of the mole percent of the second aromatic dicarboxylic acid to terephthalic acid is less than about 19:81.

Generally, the ratio of the mole percent of the second aromatic dicarboxylic acid to terephthalic acid is greater than about 1:20. More typically, the ratio of the mole percent of the second aromatic dicarboxylic acid to terephthalic acid is greater than about 2:23. Often, the ratio of the mole percent of the second aromatic dicarboxylic acid to terephthalic acid is greater than about 6:51. In some embodiments, the ratio of the mole percent of the second aromatic dicarboxylic acid is greater than about 5:26.

Generally, the ratio of the combined mole percents of all aromatic dicarboxylic acids to all linear aliphatic dicarboxylic acids is greater than 2:3. More typically, the ratio of the combined mole percents of all aromatic dicarboxylic acids to all linear aliphatic dicarboxylic acids is greater than 51:49. Often, the ratio of the combined mole percents of all aromatic dicarboxylic acids to all linear aliphatic dicarboxylic acids is greater than 56:44. In some embodiments, the ratio of the combined mole percents of all aromatic dicarboxylic acids to all linear aliphatic dicarboxylic acids is greater than 61:39.

Terephthalic acid components that are useful in the aliphatic-aromatic copolyesters include terephthalic acid, bis(glycolates) of terephthalic acid, and lower alkyl esters of terephthalic acid having from 8 to 20 carbon atoms. Specific examples of desirable terephthalic acid components include terephthalic acid, dimethyl terephthalate, bis(2-hydroxyethyl)terephthalate, bis(3-hydroxypropyl) terephthalate, bis(4-hydroxybutyl)terephthalate.

Linear aliphatic dicarboxylic acid components that are useful in the aliphatic-aromatic copolyesters include unsubstituted and methyl-substituted aliphatic dicarboxylic acids and their lower alkyl esters having from 2 to 36 carbon atoms. Specific examples of desirable linear aliphatic dicarboxylic acid components include, oxalic acid, dimethyl oxalate, malonic acid, dimethyl malonate, succinic acid, dimethyl succinate, glutaric acid, dimethyl glutarate, 3,3-dimethylglutaric acid, adipic acid, dimethyl adipate, pimelic acid, suberic acid, azelaic acid, dimethyl azelate, sebacic acid, dimethyl sebacate, undecanedioic acid, 1,10-decanedicarboxylic acid, 1,11-undecanedicarboxylic acid (brassylic acid), 1,12-dodecanedicarboxylic acid, hexadecanedioic acid, docosanedioic acid, tetracosanedioic acid, and mixtures derived therefrom. Preferably, the linear aliphatic dicarboxylic acid component is derived from a renewable biological source, in particular azelaic acid, sebacic acid, and brassylic acid. However, essentially any linear aliphatic dicarboxylic acid or derivative known can be used, including mixtures thereof.

Aromatic dicarboxylic acid components useful in the aliphatic-aromatic copolyesters include unsubstituted and methyl-substituted aromatic dicarboxylic acids, bis(glycolates) of aromatic dicarboxylic acids, and lower alkyl esters of aromatic dicarboxylic acids having from 8 carbons to 20 carbons. Examples of desirable dicarboxylic acid components include those derived from phthalates, isophthalates, naphthalates and bibenzoates. Specific examples of desirable aromatic dicarboxylic acid component include phthalic acid, dimethyl phthalate, phthalic anhydride, bis(2-hydroxyethyl)phthalate, bis(3-hydroxypropyl)phthalate, bis(4-hydroxybutyl)phthalate, isophthalic acid, dimethyl isophthalate, bis(2-hydroxyethyl)isophthalate, bis(3-hydroxypropyl)isophthalate, bis(4-hydroxybutyl)isophthalate, 2,6-naphthalene dicarboxylic acid, dimethyl-2,6-naphthalate, 2,7-naphthalenedicarboxylic acid, dimethyl-2,7-naphthalate, 1,8-naphthalene dicarboxylic acid, dimethyl 1,8-naphthalenedicarboxylate, 1,8-naphthalic anhydride, 3,4′-diphenyl ether dicarboxylic acid, dimethyl-3,4′-diphenyl ether dicarboxylate, 4,4′-diphenyl ether dicarboxylic acid, dimethyl-4,4′-diphenyl ether dicarboxylate, 3,4′-benzophenonedicarboxylic acid, dimethyl-3,4′-benzophenonedicarboxylate, 4,4′-benzophenonedicarboxylic acid, dimethyl-4,4′-benzophenonedicarboxylate, 1,4-naphthalene dicarboxylic acid, dimethyl-1,4-naphthalate, 4,4′-methylenaphthalenezoic acid), dimethyl-4,4′-methylenebis(benzoate), biphenyl-4,4′-dicarboxylic acid and mixtures derived therefrom. Typically, the second aromatic dicarboxylic acid component is derived from phthalic anhydride, phthalic acid, isophthalic acid, or mixtures thereof. However, any aromatic dicarboxylic acid or derivative known in the art can be used for the second aromatic dicarboxylic acid, including mixtures thereof. Generally, the monomers of this invention are not intended to include ionic substituents, such as anionic sulfonate and phosphate groups.

Linear glycol components that typically find use in the embodiments disclosed herein include unsubstituted and methyl-substituted aliphatic diols with 2 to 10 carbon atoms. Examples include 1,2-ethanediol, 1,2-propanediol, 1,3-propanediol, 2,2-dimethyl-1,3-propanediol, and 1,4-butanediol. Preferably, the linear glycol components are derived from a renewable biological source, in particular 1,3-propanediol and 1,4-butanediol.

Dialkylene glycol components that are found in the embodiments disclosed herein can be added to the polymerizations as monomers, but typically are generated in situ by dimerization of the linear glycol components under the conditions required for polymerization. Methods to control the dimerization of the linear glycols include monomer selection such as choice between dicarboxylic acids and their derivatives or inclusion of sulfonated monomers, catalyst selection, catalyst amount, inclusion of strong protonic acids, addition of basic compounds such as tetramethylammonium hydroxide or sodium acetate, and other process conditions such as temperatures and residence times. Generally, the dialkylene glycol component is present from about 0 to 4 mole percent based on 100 mole percent total glycol component. Typically, the dialkylene glycol component is present in at least about 0.1 mole percent based on 100 mole percent total glycol component.

The 1,3-propanediol used in the embodiments disclosed herein is preferably obtained biochemically from a renewable source (“biologically-derived” 1,3-propanediol). A particularly preferred source of 1,3-propanediol is via a fermentation process using a renewable biological source. As an illustrative example of a starting material from a renewable source, biochemical routes to 1,3-propanediol (PDO) have been described that utilize feedstocks produced from biological and renewable resources such as corn feed stock. For example, bacterial strains able to convert glycerol into 1,3-propanediol are found in the species Klebsiella, Citrobacter, Clostridium, and Lactobacillus. The technique is disclosed in several publications, including U.S. Pat. No. 5,633,362, U.S. Pat. No. 5,686,276 and U.S. Pat. No. 5,821,092. U.S. Pat. No. 5,821,092 discloses, inter alia, a process for the biological production of 1,3-propanediol from glycerol using recombinant organisms. The process incorporates E. coli bacteria, transformed with a heterologous pdu diol dehydratase gene, having specificity for 1,2-propanediol. The transformed E. coli is grown in the presence of glycerol as a carbon source and 1,3-propanediol is isolated from the growth media. Since both bacteria and yeasts can convert glucose (e.g., corn sugar) or other carbohydrates to glycerol, the processes disclosed in these publications provide a rapid, inexpensive and environmentally responsible source of 1,3-propanediol monomer.

The biologically-derived 1,3-propanediol, such as produced by the processes described and referenced above, contains carbon from the atmospheric carbon dioxide incorporated by plants, which compose the feedstock for the production of the 1,3-propanediol. In this way, the biologically-derived 1,3-propanediol preferred for use in the context of the present invention contains only renewable carbon, and not fossil fuel-based or petroleum-based carbon. The polytrimethylene terephthalate based thereon utilizing the biologically-derived 1,3-propanediol, therefore, has less impact on the environment as the 1,3-propanediol used does not deplete diminishing fossil fuels and, upon degradation, releases carbon back to the atmosphere for use by plants once again. Thus, the compositions of the present invention can be characterized as more natural and having less environmental impact than similar compositions comprising petroleum based diols.

The biologically-derived 1,3-propanediol, and polytrimethylene terephthalate based thereon, may be distinguished from similar compounds produced from a petrochemical source or from fossil fuel carbon by dual carbon-isotopic fingerprinting. This method usefully distinguishes chemically-identical materials, and apportions carbon material by source (and possibly year) of growth of the biospheric (plant) component. The isotopes, ¹⁴C and ¹³C, bring complementary information to this problem. The radiocarbon dating isotope (¹⁴C), with its nuclear half life of 5730 years, clearly allows one to apportion specimen carbon between fossil (“dead”) and biospheric (“alive”) feedstocks (Currie, L. A. “Source Apportionment of Atmospheric Particles,” Characterization of Environmental Particles, J. Buffle and H. P. van Leeuwen, Eds., 1 of Vol. I of the IUPAC Environmental Analytical Chemistry Series (Lewis Publishers, Inc) (1992) 3-74). The basic assumption in radiocarbon dating is that the constancy of ¹⁴C concentration in the atmosphere leads to the constancy of ¹⁴C in living organisms. When dealing with an isolated sample, the age of a sample can be deduced approximately by the relationship:

t=(−5730/0.693)ln(A/A₀)

wherein t=age, 5730 years is the half-life of radiocarbon, and A and A₀ are the specific ¹⁴C activity of the sample and of the modern standard, respectively (Hsieh, Y., Soil Sci. Soc. Am J., 56, 460, (1992)). However, because of atmospheric nuclear testing since 1950 and the burning of fossil fuel since 1850, ¹⁴C has acquired a second, geochemical time characteristic. Its concentration in atmospheric CO₂, and hence in the living biosphere, approximately doubled at the peak of nuclear testing, in the mid-1960s. It has since been gradually returning to the steady-state cosmogenic (atmospheric) baseline isotope rate (¹⁴C/¹²C) of ca. 1.2×10⁻¹², with an approximate relaxation “half-life” of 7-10 years. This latter half-life must not be taken literally; rather, one must use the detailed atmospheric nuclear input/decay function to trace the variation of atmospheric and biospheric ¹⁴C since the onset of the nuclear age. It is this latter biospheric ¹⁴C time characteristic that holds out the promise of annual dating of recent biospheric carbon. ¹⁴C can be measured by accelerator mass spectrometry (AMS), with results given in units of “fraction of modern carbon” (f_{M}). f_{M} is defined by National Institute of Standards and Technology (NIST) Standard Reference Materials (SRMs) 4990B and 4990C, known as oxalic acids standards HOxI and HOxII, respectively. The fundamental definition relates to 0.95 times the ¹⁴C/¹²C isotope ratio HOxI (referenced to AD 1950). This is roughly equivalent to decay-corrected pre-Industrial Revolution wood. For the current living biosphere (plant material), f_{M}≈1.1.

The stable carbon isotope ratio (¹³C/¹²C) provides a complementary route to source discrimination and apportionment. The ¹³C/¹²C ratio in a given biosourced material is a consequence of the ¹³C/¹²C ratio in atmospheric carbon dioxide at the time the carbon dioxide is fixed and also reflects the precise metabolic pathway. Regional variations also occur. Petroleum, C₃ plants (the broadleaf), C₄ plants (the grasses), and marine carbonates all show significant differences in ¹³C/¹²C and the corresponding δ ¹³C values. Furthermore, lipid matter of C₃ and C₄ plants analyze differently than materials derived from the carbohydrate components of the same plants as a consequence of the metabolic pathway. Within the precision of measurement, ¹³C shows large variations due to isotopic fractionation effects, the most significant of which for the instant invention is the photosynthetic mechanism. The major cause of differences in the carbon isotope ratio in plants is closely associated with differences in the pathway of photosynthetic carbon metabolism in the plants, particularly the reaction occurring during the primary carboxylation, i.e., the initial fixation of atmospheric CO₂. Two large classes of vegetation are those that incorporate the “C₃” (or Calvin-Benson) photosynthetic cycle and those that incorporate the “C₄” (or Hatch-Slack) photosynthetic cycle. C₃ plants, such as hardwoods and conifers, are dominant in the temperate climate zones. In C₃ plants, the primary CO₂ fixation or carboxylation reaction involves the enzyme ribulose-1,5-diphosphate carboxylase and the first stable product is a 3-carbon compound. C₄ plants, on the other hand, include such plants as tropical grasses, corn and sugar cane. In C₄ plants, an additional carboxylation reaction involving another enzyme, phosphenol-pyruvate carboxylase, is the primary carboxylation reaction. The first stable carbon compound is a 4-carbon acid, which is subsequently decarboxylated. The CO₂ thus released is refixed by the C₃ cycle.

Both C₄ and C₃ plants exhibit a range of ¹³C/¹²C isotopic ratios, but typical values are ca. −10 to −14 per mil (C₄) and −21 to −26 per mil (C₃) (Weber et al., J. Agric. Food Chem., 45, 2042 (1997)). Coal and petroleum fall generally in this latter range. The ¹³C measurement scale was originally defined by a zero set by pee dee belemnite (PDB) limestone, where values are given in parts per thousand deviations from this material. The “δ¹³C” values are in parts per thousand (per mil), abbreviated ‰, and are calculated as follows:

$${δ}^{13} C ≡ \frac{( {}^{13} C / {}^{12} C ) sample - ( {}^{13} C / {}^{12} C ) standard}{( {}^{13} C / {}^{12} C ) standard} \times 1000 \%$$

Since the PDB reference material (RM) has been exhausted, a series of alternative RMs have been developed in cooperation with the IAEA, USGS, NIST, and other selected international isotope laboratories. Notations for the per mil deviations from PDB is δ¹³C. Measurements are made on CO₂ by high precision stable ratio mass spectrometry (IRMS) on molecular ions of masses 44, 45 and 46.

Biologically-derived 1,3-propanediol, and compositions comprising biologically-derived 1,3-propanediol, therefore, may be completely distinguished from their petrochemical derived counterparts on the basis of ¹⁴C (f_{M}) and dual carbon-isotopic fingerprinting, indicating new compositions of matter. The ability to distinguish these products is beneficial in tracking these materials in commerce. For example, products comprising both “new” and “old” carbon isotope profiles may be distinguished from products made only of “old” materials. Hence, the instant materials may be followed in commerce on the basis of their unique profile and for the purposes of defining competition, for determining shelf life, and especially for assessing environmental impact.

Preferably the 1,3-propanediol used as a reactant or as a component of the reactant in making the polymers disclosed herein will have a purity of greater than about 99%, and more preferably greater than about 99.9%, by weight as determined by gas chromatographic analysis. Particularly preferred are the purified 1,3-propanediols as disclosed in U.S. Pat. No. 7,038,092, U.S. Pat. No. 7,098,368, U.S. Pat. No. 7,084,311 and US20050069997A1.

The purified 1,3-propanediol preferably has the following characteristics:

(1) an ultraviolet absorption at 220 nm of less than about 0.200, and at 250 nm of less than about 0.075, and at 275 nm of less than about 0.075; and/or

(2) a composition having a CIELAB “b*” color value of less than about 0.15 (ASTM D6290), and an absorbance at 270 nm of less than about 0.075; and/or

(3) a peroxide composition of less than about 10 ppm; and/or

(4) a concentration of total organic impurities (organic compounds other than 1,3-propanediol) of less than about 400 ppm, more preferably less than about 300 ppm, and still more preferably less than about 150 ppm, as measured by gas chromatography.

In general, the aliphatic-aromatic copolyesters can be polymerized from the disclosed monomers by any process known for the preparation of polyesters. Such processes can be operated in either a batch, semi-batch, or in a continuous mode using suitable reactor configurations. The specific batch reactor process used to prepare the polymers disclosed in the embodiments herein is equipped with a means for heating the reaction to 260° C., a fractionation column for distilling off volatile liquids, an efficient stirrer capable of stirring a high viscosity melt, a means for blanketing the reactor contents with nitrogen, and a vacuum system capable of achieving a vacuum of less than 1 Torr.

This batch process was generally carried out in two steps. In the first step, dicarboxylic acid monomers or their derivatives were reacted with a diol in the presence of an ester interchange catalyst. This resulted in the formation of alcohol and/or water, which distilled out of the reaction vessel, and diol adducts of the dicarboxylic acids. The exact amount of monomers charged to the reactor was readily determined by a skilled practitioner depending on the amount of polymer desired and its composition. It was advantageous to use excess diol in the ester interchange step, with the excess distilled off during the second, polycondensation step. A diol excess of 10 to 100% was commonly used. Catalysts are generally known in the art, and preferred catalysts for this process were titanium alkoxides. The amount of catalyst used was usually 20 to 200 parts titanium per million parts polymer. The combined monomers are heated gradually with mixing to a temperature in the range of 200 to 250° C. Depending on the reactor and the monomers used, the reactor may be heated directly to 250° C., or there may be a hold at a temperature in the range of 200 to 230° C. to allow the ester interchange to occur and the volatile products to distill out without loss of the excess diol. The ester interchange step was usually completed at a temperature ranging from 240 to 260° C. The completion of the interchange step was determined from the amount of alcohol and/or water collected and by falling temperatures at the top of the distillation column.

The second step, polycondensation, was carried out at 240 to 260° C. under vacuum to distill out the excess diol. It was preferred to apply the vacuum gradually to avoid bumping of the reactor contents. Stirring was continued under full vacuum (less than 1 Torr) until the desired melt viscosity was reached. A practitioner experienced with the reactor was be able to determine if the polymer had reached the desired melt viscosity from the torque on the stirrer motor.

It is generally preferred that the aliphatic-aromatic copolyesters have sufficiently high molecular weights to provide suitable melt viscosity for processing into shaped articles, and useful levels of mechanical properties in said articles. Generally, weight average molecular weights (Mw) from about 20,000 g/mol to about 150,000 g/mol are useful. More typical are Mw from about 50,000 g/mol to about 130,000 g/mol. Most typical are Mw from about 80,000 g/mol to about 110,000 g/mol. In practical terms, molecular weights are often correlated to solution viscosities, such as intrinsic or inherent viscosity. While the exact correlation depends on the composition of a given copolymer, the molecular weights above generally correspond to intrinsic viscosity (IV) values from about 0.5 dL/g to about 2.0 dL/g. More typical are IV values from about 1.0 dL/g to about 1.8 dL/g. Most typical are IV values from about 1.3 dL/g to about 1.6 dL/g. Although the copolyesters prepared by the processes disclosed herein reach satisfactory molecular weights, it can be expedient to use chain extenders to rapidly increase the said molecular weights and minimize their thermal history while reducing the temperature and contact time of the interchange and polycondensation steps. Suitable chain extenders include diisocyanates, polyisocyanates, dianhydrides, diepoxides, polyepoxides, bis-oxazolines, carbodiimides, and divinyl ethers, which can be added at the end of the polycondensation step, during processing on mechanical extrusion equipment, or during processing of the copolyesters into desired shaped articles. Specific examples of desirable chain extenders include hexamethylene diisocyanate, methylene bis(4-phenylisocyanate), and pyromellitic dianhydride. Such chain extenders are typically used at 0.1 to 2 weight percent with respect to the copolyesters.

The molecular weights of the aliphatic-aromatic copolyesters can also be increased by post-polymerization processes, such as solid-phase polymerization and vacuum extrusion, both of which allow the efficient removal of any volatiles generated by polycondensation at their respective scales of temperature and time. The benefit of these processes is that the composition of the copolyesters remains unperturbed by the processing conditions. In solid-phase polymerization, a polyester or copolyester is held at a temperature below its melting point, more typically below the temperature at which the polymer particles begin to stick, and subjected to vacuum or a flow of dry atmosphere. This process is most beneficial for polyesters, such as polyethylene terephthalate, polytrimethylene terephthalate, and polybutylene terephthalate, which contain little or no comonomers that substantially reduce their melting points, typically greater than 200° C. In vacuum extrusion, a polyester or copolyester is fed to a mechanical extruder at a suitable temperature to melt them and then subjected to high vacuum. This process is most beneficial for copolyesters, including all of the compositions whose preparation is described herein, due to their lower melting points, typically less than 200° C. In each process, the temperature and time that is needed to obtain the necessary increase in molecular weight due to polycondensation can be determined by taking samples or by monitoring the process outputs, such as the torque reading for the mechanical extruder.

Suitable mechanical extruders on which to process the copolyesters are well known in the art and can be purchased from commercial vendors. For example, extruders and kneader reactors can be advantageously employed in vacuum extrusion, including single shaft, twin shaft, corotatory, or contrarotatory units. Twin-screw extruders are available from Coperion Werner & Pfleiderer (Stuttgart, Germany), and continuous kneader reactors from BUSS AG (LR series, Pratteln, Switzerland) and LIST AG (Arisdorf, Switzerland). These units are designed as continuous plug flow reactors for polycondensations in the viscous phase up to high conversions and accordingly have a large L/D ratio of from about 5 to approximately 40.

Alternatively, the melt viscosity can be increased by incorporating a branching agent into the copolyesters during polymerization to introduce long-chain branches. Suitable branching agents include trifunctional and polyfunctional compounds containing carboxylic acid functions, hydroxy functions, or mixtures thereof. Specific examples of desirable branching agents include 1,2,4-benzenetricarboxylic acid, (trimellitic acid), trimethyl-1,2,4-benzenetricarboxylate, 1,2,4-benzenetricarboxylic anhydride, (trimellitic anhydride), 1,3,5-benzenetricarboxylic acid (trimesic acid), 1,2,4,5-benzenetetracarboxylic acid (pyromellitic acid), 1,2,4,5-benzenetetracarboxylic dianhydride (pyromellitic dianhydride), 3,3′,4,4′-benzophenonetetracarboxylic dianhydride, 1,4,5,8-naphthalenetetracarboxylic dianhydride, 1,3,5-cyclohexanetricarboxylic acid, pentaerythritol, glycerol, 2-(hydroxymethyl)-1,3-propanediol, 1,1,1-tris(hydroxymethyl)propane, 2,2-bis(hydroxymethyl)propionic acid, and mixtures derived therefrom. Such branching agents are typically used at 0.01 to 0.5 mole percent with respect to the dicarboxylic acid component or the glycol component as dictated by the majority functional group of the branching agent.

Additionally, the thermal behavior of the copolyesters can be adjusted to an extent by incorporating nucleating agents during polymerization or processing of the copolyesters to accelerate their crystallization rates and provide a more uniform distribution of crystallites throughout the bulk of the polymer. In such manner, the processing of the copolyesters can be improved by maintaining a more uniform and consistent thermal quenching of the molten polymer potentially leading to improvement in the mechanical properties of the shaped articles. Particularly suitable nucleating agents include sodium salts of carboxylic acids and polymeric ionomers partially or fully neutralized with sodium cations. If incorporated during polymerization, lower molecular weight sodium salts are typically used and can be added with the monomers or later in the process, such as after completion of the interchange step and before or during the polycondensation step. If compounded into a finished copolyester, higher molecular weight sodium salts and the polymeric ionomers are typically used and can be added during mechanical extrusion with sufficient mixing. Specific examples of desirable nucleating agents include sodium acetate, sodium acetate trihydrate, sodium formate, sodium bicarbonate, sodium benzoate, monosodium terephthalate, sodium stearate, sodium erucate, sodium montanate (Licomont® NaV 101, Clariant), Surlyn® sodium ionomers (ethylene-methacrylic acid sodium ionomers, DuPont™) and AClyn® 285 (low molecular weight ethylene-acrylic acid sodium ionomer, Honeywell International, Inc.). Such nucleating agents are typically used at levels that deliver 10 to 1000 ppm sodium with respect to the copolyesters.

The aliphatic-aromatic copolyesters can be blended with other polymeric materials. Such polymeric materials can be biodegradable or not biodegradable, and can be naturally derived, modified naturally derived or synthetic.

Examples of biodegradable polymeric materials suitable for blending with the aliphatic-aromatic copolyesters include poly(hydroxy alkanoates), polycarbonates, poly(caprolactone), aliphatic polyesters, aliphatic-aromatic copolyesters, aliphatic-aromatic copolyetheresters, aliphatic-aromatic copolyamideesters, sulfonated aliphatic-aromatic copolyesters, sulfonated aliphatic-aromatic copolyetheresters, sulfonated aliphatic-aromatic copolyamideesters, and copolymers and mixtures derived therefrom. Specific examples of blendable biodegradable materials include the Biomax® sulfonated aliphatic-aromatic copolyesters of the DuPont Company, the Eastar Bio® aliphatic-aromatic copolyesters of the Eastman Chemical Company, the Ecoflex® aliphatic-aromatic copolyesters of the BASF corporation, poly(1,4-butylene terephthalate-co-adipate, (50:50, molar), the EnPol® polyesters of the IRe Chemical Company, poly(1,4-butylene succinate), the Bionolle® polyesters of the Showa High Polymer Company, poly(ethylene succinate), poly(1,4-butylene adipate-co-succinate), poly(1,4-butylene adipate), poly(amide esters), the Bak® poly(amide esters) of the Bayer Company, poly(ethylene carbonate), poly(hydroxybutyrate), poly(hydroxyvalerate), poly(hydroxybutyrate-co-hydroxyvalerate), the Biopol® poly(hydroxy alkanoates) of the Monsanto Company, poly(lactide-co-glycolide-co-caprolactone), the Tone® poly(caprolactone) of the Union Carbide Company, the EcoPLA® poly(lactide) of the Cargill Dow Company and mixtures derived therefrom. Essentially any biodegradable material can be blended with the aliphatic-aromatic copolyesters.

Examples of nonbiodegradable polymeric materials suitable for blending with the aliphatic-aromatic copolyesters include polyethylene, high density polyethylene, low density polyethylene, linear low density polyethylene, ultralow density polyethylene, polyolefins, ply(ethylene-co-glycidylmethacrylate), poly(ethylene-co-methyl (meth)acrylate-co-glycidyl acrylate), poly(ethylene-co-n-butyl acrylate-co-glycidyl acrylate), poly(ethylene-co-methyl acrylate), poly(ethylene-co-ethyl acrylate), poly(ethylene-co-butyl acrylate), poly(ethylene-co-(meth) acrylic acid), metal salts of poly(ethylene-co-(meth)acrylic acid), poly((meth)acrylates), such as poly(methyl methacrylate), poly(ethyl methacrylate), poly(ethylene-co-carbon monoxide), poly(vinyl acetate), poly(ethylene-co-vinyl acetate), poly(vinyl alcohol), poly(ethylene-co-vinyl alcohol), polypropylene, polybutylene, polyesters, poly(ethylene terephthalate), poly(1,3-propyl terephthalate), poly(1,4-butylene terephthalate), poly(ethylene-co-1,4-cyclohexanedimethanol terephthalate), poly(vinyl chloride), poly(vinylidene chloride), polystyrene, syndiotactic polystyrene, poly(4-hydroxystyrene), novalacs, poly(cresols), polyamides, nylon, nylon 6, nylon 46, nylon 66, nylon 612, polycarbonates, poly(bisphenol A carbonate), polysulfides, poly(phenylene sulfide), polyethers, poly(2,6-dimethylphenylene oxide), polysulfones, and copolymers thereof and mixtures derived therefrom.

Examples of natural polymeric materials suitable for blending with the aliphatic-aromatic copolyesters include starch, starch derivatives, modified starch, thermoplastic starch, cationic starch, anionic starch, starch esters, such as starch acetate, starch hydroxyethyl ether, alkyl starches, dextrins, amine starches, phosphate starches, dialdehyde starches, cellulose, cellulose derivatives, modified cellulose, cellulose esters, such as cellulose acetate, cellulose diacetate, cellulose propionate, cellulose butyrate, cellulose valerate, cellulose triacetate, cellulose tripropionate, cellulose tributyrate, and cellulose mixed esters, such as cellulose acetate propionate and cellulose acetate butyrate, cellulose ethers, such as methylhydroxyethylcellulose, hydroxymethylethylcellulose, carboxymethylcellulose, methyl cellulose, ethylcellulose, hydroxyethylcellulose, and hydroxyethylpropylcellulose, polysaccharides, alginic acid, alginates, phycocolloids, agar, gum arabic, guar gum, acacia gum, carrageenan gum, furcellaran gum, ghatti gum, psyllium gum, quince gum, tamarind gum, locust bean gum, gum karaya, xanthan gum, gum tragacanth, proteins, prolamine, collagen and derivatives thereof such as gelatin and glue, casein, sunflower protein, egg protein, soybean protein, vegetable gelatins, gluten, and mixtures derived therefrom. Thermoplastic starch can be produced, for example, as disclosed within U.S. Pat. No. 5,362,777. Essentially any natural polymeric material known can be blended with the aliphatic-aromatic copolyesters.

The aliphatic-aromatic copolyesters and blends formed therefrom can be used to make a wide variety of shaped articles. Shaped articles that can be made from the aliphatic-aromatic copolyesters include films, sheets, fibers, filaments, bags, melt blown containers, molded parts such as cutlery, coatings, polymeric melt extrusion coatings on substrates, polymeric solution coatings onto substrates, laminates, and bicomponent, multi-layer, and foamed varieties of such shaped articles. The aliphatic-aromatic copolyesters are useful in making any shaped article that can be made from a polymer. The aliphatic-aromatic copolyesters can be formed into such shaped articles using any known process therefore, including thermoplastic processes such as compression molding, thermoforming, extrusion, coextrusion, injection molding, blow molding, melt spinning, film casting, film blowing, lamination, foaming using gases or chemical foaming agents, or any suitable combination thereof to prepare the desired shaped article.

Shaped articles, particularly those that find use in packaging, including films, bags, containers, cups, and trays among others, are typically desired to be compostable. The current standards for compostable packaging and packaging materials are described in ASTM D6400-04 and EN 13432:2000. As the more stringent standard, EN 13432 is more pertinent for the qualification of new compostable packaging materials. To qualify as compostable, the packaging must disintegrate in 3 months under the conditions of an industrial composting facility and biodegrade to carbon dioxide at the level of 90% in 6 months without any negative impact due to toxicity on the composting process or on plant growth using the resulting compost. In this regard, the aliphatic-aromatic copolyesters disclosed herein can be said to be biodegradable when their shaped articles used as packaging materials, such as films, are shown to be compostable. In a typical embodiment of this invention, the shaped articles comprise films that are compostable at thicknesses of up to 20 microns, more typically up to 70 microns, in some embodiments up to 120 microns, and in yet other embodiments greater than 120 microns.

The aliphatic-aromatic copolyesters and blends formed therefrom are particularly well suited for the extrusion and blowing of compostable films with high tear strength. Films are commonly tested for tear strength according to the Elmendorf method as described in ASTM D1922-09. In typical applications for films, such as bags, the tear strength must be at least 1000 g/mm, but higher values, such as those greater than 5000 g/mm are desirable as they allow a thinner gauge to be used. Values greater than 8000 g/mm, 12000 g/mm, or even 16000 g/mm can provide additional benefits when balanced with other properties desired for a given application. The aliphatic-aromatic copolyesters of this invention provide films that can attain these levels of tear strength and that show enhancement in tear strength when compared to prior art copolyesters with similar terephthalic acid contents. The enhancement is apparent when the linear glycol is 1,4-butanediol and particularly apparent when the linear glycol is 1,3-propanediol. Hence, the enhancement in tear strength can be reasonably expected to be apparent when other linear glycols are used. Further enhancement of tear strength is possible by blending aliphatic-aromatic copolyesters with other materials, particularly polymeric materials such as starch, to give values greater than 10000 g/mm, 15000 g/mm, or even 20000 g/mm.

The aliphatic-aromatic copolyesters, their blends, and the shaped articles formed therefrom can include any known additive used in polyesters as a processing aid or for end-use properties. The additives are preferably nontoxic, biodegradable, and derived from renewable biological sources. Such additives include compatibilizers for the polymer blend components, antioxidants, thermal and UV stabilizers, flame retardants, plasticizers, flow enhancers, slip agents, rheology modifiers, lubricants, tougheners, pigments, antiblocking agents, inorganic and organic fillers, such as silica, clay, talc, chalk, titanium dioxide, carbon black, wood flour, keratin, chitin, refined feathers and reinforcing fibers, such as glass fibers and natural fibers like paper, jute and hemp.

### Test Methods

The intrinsic viscosity (IV) of the copolyesters was determined using a Viscotek Forced Flow Viscometer (FFV) Model Y-900. Samples were dissolved in 50/50 wt % trifluoroacetic acid/methylene chloride (TFA/CH₂Cl₂) at a 0.4% (wt/vol) concentration at 19° C. The intrinsic viscosity values reported by this method were equivalent to values determined using Goodyear Method R-103b “Determination of Intrinsic Viscosity in 50/50 [by weight] Trifluoroacetic Acid/Dichloromethane”. This method can be applied to any polyester (i.e. PET, 3GT, PBT, PEN) which is completely soluble in the 50/50 wt % TFA/CH₂Cl₂ solvent mixture. A sample size of 0.1000 g polyester was typically used to prepare a 25 ml polymer solution. Complete dissolution of the polymer generally occurred within 8 hours at room temperature. Dissolution time was dependent on the molecular weight, crystallinity, chemical structure, and form (i.e. fiber, film, ground, and pellet) of the polyester.

The compositions of the polymers were determined by Nuclear Magnetic Resonance Spectroscopy, NMR. Several pellets or flakes for each sample were dissolved in trifluoroacetic acid-d1 at room temp (one can also heat the sample to 50° C. without seeing any structural changes in order to speed up dissolution). The solution was transferred into a 5 mm NMR tube and the spectrum was obtained at 30° C. on a Varian S 400 MHz Spectrometer. Mole-% composition of the sample was calculated from the integrations of appropriate areas of the spectrum.

Differential Scanning calorimetry, DSC, was performed on a TA Instruments (New Castle, Del.) Model Number 2920 under a nitrogen atmosphere. Samples were heated from 20° C. to 270° C. at 20° C./min., held at 270° C. for 5 min., quenched in liquid N2, heated from −100° C. to 270° C. at 10° C./min.(Tg), held at 270° C. for 3 min., cooled to −100° C. at 10° C./min. (Tc), held at −100° C. for 2 minutes, and heated from −100° to 270° C. at 10 C/min. (Tc and Tm).

Pressed films of the polymers were prepared for testing as follows. Approximately 1.7 grams of each polymer sample was placed between aluminum foil sheets coated with Teflon® and separated by a 3 to 5 mil spacer. This composite was placed between metal plates and inserted into a press set to a temperature approximately 50° C. above the melt temperature of the polymer. Pressures of approximately 3000 psi and 15000 psi were sequentially applied to the composite and maintained for approximately 3 minutes each. The composite was then removed from the press and metal plates and allowed to cool to room temperature. Separation of the composite produced free films that were approximately 5 mils thick. The pressed films were tested for Elmendorf tear strength according to ASTM D1922-09. The reported values for each example in Table 2 are the averages of at least five replicates.

The pressed films were also used to screen for biodegradation potential by digestion in enzyme solution as follows. The films were die cut to precisely 3 inch by 1 inch strips, which were measured at 3 locations for thickness so that an accurate surface area could be determined. The strips were then cleaned via a series of rinses and 3 minutes of mild sonication in deionized water and placed into clean dry vials. They were dried in a vacuum oven with a slow nitrogen bleed at about 65° C. and about 150 Torr for 24 hours and then weighed immediately upon removal. They were then returned to clean dry vials and exposed to UV light (15 Watts, 320 nm) for 30 minutes at room temperature for sterilization. Caps to the vials were exposed to UV light in a similar manner. For each condition, 5 replicate strips were prepared as described above.

A 10 mM potassium phosphate solution buffered at pH=8.0 was created by combining 9.4 mL of 1M potassium phosphate dibasic solution (EM Science, cat #PX1570-1) and 0.6 ml of 1M potassium phosphate monobasic solution (EM Science, cat #PX1565-1) with molecular grade water (distilled, deionized, Cellgro Cat# 46-000-cm) to generate each liter of solution. Lipase from Thermomyces lanuginosus (0.49 mL), lipase from Rhizomucor miehei (0.22 mL), lipase from Chromobacterium viscosum (0.75 mg), lipase from Mucor miehei (0.50 mg), and lipase from Pseudomonas sp. (99 mg) were added to the buffer solution to create 500 mL of enzyme solution. The enzyme solution was then sterilized by passage through a 0.45 micron filter. Approximately 15 mL of the enzyme solution was added to each prepared sample vial, which was subsequently capped and placed on a rotary orbital shaking platform set to 300 rpm in an incubator set to 37° C. After 1 week, the incubator temperature was increased to 50° C. After 2 additional weeks, the polymer strips were removed from the vials, cleaned via a series of rinses and 3 minutes of mild sonication in deionized water and placed into new clean dry vials. They were dried in a vacuum oven with a slow nitrogen bleed at about 65° C. and about 150 Torr for 24 hours and then weighed immediately upon removal. The average weight loss for the five replicates of each example is reported in Table 2.

Screening for compostability was carried out as follows. Polymer was fed into a 1.5 inch Davis single screw extruder with L/D of 27 set to 30 rpm. A 50/50 blend of talc in polyethylene methyl acrylate) was included at a rate of 1.5% relative to the polymer as an antiblock agent. Heating zones were set to about 140° C. at entrance and at about 155° C. for the remainder of the barrel. Melt temperatures at exit were about 170° C. Films were extruded from a 14 inch die with a 10 mil gap onto a chill roll set to about 12° C. These films were supplied to Organic Waste Systems (Gent, Belgium) for pilot-scale composting trials that mimic as closely as possible a real and complete composting process. Specifically, film samples were cut into small pieces and fixed into slide frames such that both surfaces were available for exposure. These were mixed with the organic fraction of fresh, pretreated municipal solid waste and introduced into an insulated composting vessel (200 L) after which composting spontaneously started. Like in full-scale composting, inoculation and temperature increase occurred spontaneously. The natural composting was regulated through air flow and moisture content. The temperature and exhaust gas composition were regularly monitored. The composting process was continued until fully stabilized compost was obtained (3 months). Minimum temperature conditions must be met for the test to be considered valid. For this purpose the composting vessels were put into an incubation room at a prefixed temperature of 45° C. At each turning interval (every week during first 6 weeks, every 2 weeks thereafter) the slides were carefully inspected visually and representative examples are taken out and stored. Thereby, this screening method provided indication about the potential for a given sample to pass the disintegration portion of EN 13432.

Extruded films were prepared as follows for tensile testing. Polymer samples were first dried at 70-100° C. for 16 hours before running in extruder. Pellets were loaded into the twin screw extruder, a DSM Micro 15 Twin Screw Compounder (200-245 V, 50-56 Hz, 2500 W, 11.5 A, DSM Research, Netherlands). The loading tube was purged with dry nitrogen to minimize degradation. The melt zone temperature was set 30° C. above the polymer melting point. The polymers were mixed for 3-4 minutes at 200 rpm. The extruder was purged 4 times with a particular sample to remove any traces of previous samples. The fifth loading of a sample was kept for analysis. Molten polymer was delivered to a 0.4 mm film die. The film then passed to a chilled roller for casting and then was wound on a take-up roll. An air knife was placed between the die and the chilled roller to help cool the film. Films were 8-12 mil (0.20-0.30 mm) thick, about 3 cm wide, and at least 3 feet (0.91 m) long. Samples were prepared from these films and tested for tensile properties according to ASTM D882.

1,3-Propanediol was obtained from DuPont/Tate & Lyle, Loudon, Tenn., USA. All other chemicals, reagents and materials, unless otherwise indicated, were obtained from Aldrich Chemical Company, Milwaukee, Wis., USA.

### EXAMPLES

The copolyesters of Examples 1-25, Comparative Examples (CE's) 1-13, and Comparative Examples 16-19 were synthesized on the laboratory scale by the following general procedure with only minor variation to the listed times and temperatures. To a 250 mL or 1 L glass flask were added the mass of monomers listed in Table 1 below. The reaction mixture was stirred while the vessel was evacuated by vacuum to 100 Torr and brought back to atmospheric pressure under nitrogen 3 times. While applying continuous stirring and a nitrogen atmosphere, the reaction vessel was immersed in a liquid metal batch set to 160° C. When dimethyl esters were present in the reaction mixture, temperature was increased to about 210° C. over the course of about 45 minutes. The reaction mixture was held at this temperature under the nitrogen atmosphere with continuous stirring for about 30 minutes at which point the production of distillate had slowed considerably. The reaction mixture was then heated to 250° C. over 30 minutes and held at this temperature for about 1.5 hours at the end of which production of distillate had nearly ceased. When dimethyl esters were not present in the reaction mixture, temperature was increased directly to 250° C. over the course of about 45 minutes and held at that temperature for about 2 hours at the end of which production of distillate had nearly ceased. The reaction vessel was then staged to full vacuum (typically <100 mTorr) over the course of about 30 minutes with continuous stirring at 250° C. The vessel was held under these conditions for a further 3 hours or more while additional distillate was collected. Vacuum was then released with nitrogen, and the reaction mixture was allowed to return to room temperature.

The copolyesters of Comparative Examples 14-15 were synthesized by the following general procedure with only minor variation to the listed times and temperatures. To a 100 gallon reactor were added the mass of monomers listed in Table 1 below. The reactor was purged with nitrogen 3 times to a pressure of 50 psig and returned to atmospheric pressure with a continuous low flow nitrogen sweep. The reaction mixture was stirred while the temperature was raised to about 180° C. over the course of about 75 minutes. At about that temperature distillate collection began, and the temperature was raised to about 230° C. over the course of about 3 additional hours. After that time, distillate production had nearly ceased, and the reaction mixture was transferred to a 60 gallon reactor at about 230° C. Once the transfer was complete, the batch was mixed while pressure was reduced to approximately 0.3 Torr over the course of approximately 1 hour and temperature was increased to approximately 255° C. over the course of about 2 hours. The vessel was held under these conditions for about an additional 4.5 hours while additional distillate was collected. Vacuum was then released with nitrogen, and positive pressure was applied to force the polymer from the bottom of the reaction vessel. The polymer was cast into a ribbon that was subsequently chopped into flake.

Table 1 includes the details of the synthesis of each example, including whether acids, methyl esters, or anhydrides were used in each specific synthesis. Under laboratory analysis, each example was determined to have the properties listed in Table 2 below.

Abbreviations used in the tables below are as follows: 3G (1,3-propanediol), 4G (1,4-butanediol), TPA (terephthalic acid), DMT (dimethyl terephthalate), DMSuc (dimethyl succinate), Adi (adipic acid), DMAdi (dimethyl adipate), Seb (sebacic acid), DMSeb (dimethyl sebacate), PAnh (phthalic anhydride), IPA (isophthalic acid), Glu (glutaric acid), 2,6-NDC (dimethyl 2,6-naphthalenedicarboxylate), 4,4′-OBBA (4,4′-oxybis(benzoic acid)), 4,4′-BPDCA (biphenyl-4,4′-dicarboxylic acid), 1,8-NAnh (1,8-naphthalic anhydride), TPT (Tyzor® TPT), DAG (dialkylene glycol), Elm Tear (Elmendorf Tear Strength), PTMEG (poly(tetramethylene ether)glycol), NaOAc-3H₂O (sodium acetate trihydrate), and NaO2CH (sodium formate).

### Comparative Examples 1-7

A series of copolyesters were synthesized from 1,3-propanediol, dimethyl terephthalate or terephthalic acid, and sebacic acid. Variation of the terephthalic acid content of these aliphatic-aromatic copolyesters had only a modest impact on tear strength. When tested according to ASTM D882 at a strain rate of 500%/min, Comparative Example 3 was determined to have a modulus of 77 MPa, a tensile strength of 35 MPa, and an ultimate elongation of 770%.

### Comparative Examples 8-9

Copolyesters were synthesized from 1,3-propanediol, dimethyl terephthalate, sebacic acid and either adipic acid or glutaric acid. Addition of a second linear aliphatic dicarboxylic acid to these aliphatic-aromatic copolyesters had little impact on tear strength relative to Comparative Examples 1-7 with similar terephthalic acid contents.

### Comparative Examples 10-11

Copolyesters were synthesized from 1,3-propanediol, terephthalic acid, sebacic acid and poly(tetramethylene ether)glycols at two different molecular weights. Addition of a poly(alkylene ether)glycol to these aliphatic-aromatic copolyesters had little impact on tear strength relative to Comparative Examples 1-7 with similar terephthalic acid contents. When tested according to ASTM D882 at a strain rate of 500%/min, Comparative Example 10 was determined to have a modulus of 49 MPa, a tensile strength of 13 MPa, and an ultimate elongation of 885%. Addition of a poly(alkylene ether)glycol to these aliphatic-aromatic copolyesters had a negative impact on tensile properties and little impact on tear strength.

### Examples 1-10

Copolyesters were synthesized from 1,3-propanediol, dimethyl terephthalate or terephthalic acid, sebacic acid, and phthalic anhydride. Addition of phthalic anhydride to these aliphatic-aromatic copolyesters dramatically increased tear strength relative to Comparative Examples 1-7 with similar terephthalic acid contents. When tested according to ASTM D882 at a strain rate of 500%/min, Example 3 was determined to have a modulus of 117 MPa, a tensile strength of 32 MPa, and an ultimate elongation of 655%. Similarly, Example 9 was found to have a modulus of 65 MPa, a tensile strength of 31 MPa, and an ultimate elongation of 779%. Addition of phthalic anhydride to these aliphatic-aromatic copolyesters had a modest impact on tensile properties and dramatically increased tear strength.

### Examples 11-16

Copolyesters were synthesized from 1,3-propanediol, dimethyl terephthalate or terephthalic acid, sebacic acid, and isophthalic acid. Addition of isophthalic acid to these aliphatic-aromatic copolyesters dramatically increased tear strength relative to Comparative Examples 1-7 with similar terephthalic acid contents. When tested according to ASTM D882 at a strain rate of 500%/min, Example 15 was determined to have a modulus of 103 MPa, a tensile strength of 30 MPa, and an ultimate elongation of 737%. Addition of isophthalic acid to these aliphatic-aromatic copolyesters had a modest impact on tensile properties and dramatically increased tear strength.

### Examples 17-20

Copolyesters were synthesized from 1,3-propanediol, dimethyl terephthalate, sebacic acid, and each of the following: 1,8-naphthalic anhydride, dimethyl 2,6-naphthalenedicarboxylate, 4,4′-oxybis(benzoic acid), or biphenyl-4,4′-dicarboxylic acid. In each case, tear strength was dramatically increased relative to Comparative Examples 1-7 with similar terephthalic acid contents.

### Comparative Examples 12-13

Copolyesters were synthesized from 1,4-butanediol, dimethyl terephthalate, and either dimethyl sebacate or dimethyl adipate. These aliphatic-aromatic copolyesters based on 1,4-butanediol have higher tear strengths than the aliphatic-aromatic copolyesters based on 1,3-propanediol in Comparative Examples 1-9 with similar terephthalic acid contents.

### Examples 21-22

Copolyesters were synthesized from 1,4-butanediol, dimethyl terephthalate, phthalic anhydride and either dimethyl sebacate or dimethyl adipate. Addition of phthalic anhydride to these aliphatic-aromatic copolyesters dramatically increased tear strength relative to Comparative Examples 12-13 with similar terephthalic acid contents.

### Comparative Examples 14 & 15

Copolyesters were synthesized from 1,3-propanediol, dimethyl terephthalate, and sebacic acid. They were cast into films with a thickness of 120 microns. When subjected to the pilot scale composting test, they disintegrated prior to 12 weeks. Weight loss of Comparative Example 14 during enzyme digestion was 2.0%, indicating that this degree of weight loss in the enzyme digestion test correlates to complete disintegration in the pilot scale composting test prior to 12 weeks. Weight loss of Comparative Example 15 during enzyme digestion was 2.3%, indicating that this degree of weight loss in the enzyme digestion test correlates to complete disintegration in the pilot scale composting test prior to 12 weeks.

### Comparative Example 16

A copolyester was synthesized from 1,3-propanediol, dimethyl terephthalate, and sebacic acid to generate a polymer with approximately the same monomer content as Comparative Example 14. 60 mole % of the dicarboxylic acid component was derived from aromatic monomers. Weight loss during enzyme digestion was 3.1%, indicating that this degree of weight loss in the enzyme digestion test correlates to complete disintegration in the pilot scale composting test prior to 12 weeks.

### Comparative Example 17

The copolyester of Comparative Example 2 has approximately the same monomer content as Comparative Example 15. 54 mole % of the dicarboxylic acid component was derived from aromatic monomers. Weight loss during enzyme digestion was 1.8%, indicating that this degree of weight loss in the enzyme digestion test correlates to complete disintegration in the pilot scale composting test prior to 12 weeks.

### Comparative Example 18

A copolyester was synthesized from 1,3-propanediol, dimethyl terephthalate, and sebacic acid. 64 mole % of the dicarboxylic acid component was derived from aromatic monomers. Weight loss during enzyme digestion was 2.3% illustrating that, in general, aliphatic-aromatic copolyesters which derive 64 mole % of their dicarboxylic acid component from aromatic monomers are likely to disintegrate in the pilot scale composting test.

### Example 23

A copolyester was synthesized from 1,3-propanediol, dimethyl terephthalate, sebacic acid, and phthalic anhydride. 64 mole % of the dicarboxylic acid component was derived from aromatic monomers. Weight loss during enzyme digestion was 4.8% illustrating that the aliphatic-aromatic copolyesters of this invention can be expected to show enhanced disintegration in the pilot scale composting test even when 64 mole % of their dicarboxylic acid component is derived from aromatic monomers. Relative to Comparative Example 18, this example included an appreciable fraction of phthalic anhydride, which led to faster degradation in enzyme solution and can be reasonably expected to lead to enhanced biodegradation and compostability.

### Example 24

A copolyester was synthesized from 1,3-propanediol, dimethyl terephthalate, sebacic acid, and phthalic anhydride. 64 mole % of the dicarboxylic acid component was derived from aromatic monomers. Weight loss during enzyme digestion was 2.5% illustrating that the aliphatic-aromatic copolyesters of this invention can be expected to disintegrate in the pilot scale composting test even when 64 mole % of their dicarboxylic acid component is derived from aromatic monomers.

### Comparative Example 19

A copolyester was synthesized from 1,3-propanediol, dimethyl terephthalate, and sebacic acid. 72 mole % of the dicarboxylic acid component was derived from aromatic monomers. Weight loss during enzyme digestion was 1.8% illustrating that even aliphatic-aromatic copolyesters which derive 72 mole % of their dicarboxylic acid component from aromatic monomers may disintegrate in the pilot scale composting test.

### Example 25

A copolyester was synthesized from 1,3-propanediol, dimethyl terephthalate, sebacic acid, and phthalic anhydride. 72 mole % of the dicarboxylic acid component was derived from aromatic monomers. Weight loss during enzyme digestion was 5.4% illustrating that the aliphatic-aromatic copolyesters of this invention can be expected to show enhanced disintegration in the pilot scale composting test even when 72 mole % of their dicarboxylic acid component is derived from aromatic monomers. Relative to Comparative Example 19, this example included an appreciable fraction of phthalic anhydride, which led to faster degradation in enzyme solution and can be reasonably expected to lead to enhanced biodegradation and compostability.

Examples 26-29 are presented to illustrate the potential use of these polymers in blends.

### Example 26

Into a twin-screw extruder with a temperature profile that ranges from 60° C. to 185° C. is fed the following mixture: the aliphatic-aromatic copolyester of Example 3 (61.6 wt %), corn starch (28.4 wt %), glycerol (5.7 wt %), and water (4.3 wt %). The extruded material is pelletized and subsequently pressed into a film. The film is homogeneous and has good mechanical properties.

### Example 27

Into a twin-screw extruder with a temperature profile that ranges from 60° C. to 200° C. is fed the following mixture: the aliphatic-aromatic copolyester of Example 3 (70 wt %) and poly(lactic acid) (30 wt %). The extruded material is pelletized and subsequently pressed into a film. The film is homogeneous and has good mechanical properties.

### Example 28

Into a twin-screw extruder with a temperature profile that ranges from 60° C. to 185° C. is fed the following mixture: the aliphatic-aromatic copolyester of Example 21 (61.6 wt %), corn starch (28.4 wt %), glycerol (5.7 wt %), and water (4.3 wt %). The extruded material is pelletized and subsequently pressed into a film. The film is homogeneous and has good mechanical properties.

### Example 29

Into a twin-screw extruder with a temperature profile that ranges from 60° C. to 200° C. is fed the following mixture: the aliphatic-aromatic copolyester of Example 21 (70 wt %) and poly(lactic acid) (30 wt %). The extruded material is pelletized and subsequently pressed into a film. The film is homogeneous and has good mechanical properties.

Examples 30-35 are presented to illustrate the potential use of these polymers in shaped articles.

### Example 30

The aliphatic-aromatic copolyester of Example 3 is extruded at 165° C. into an annular die and blown into film. The film is homogeneous and has good mechanical properties.

### Example 31

The aliphatic-aromatic copolyester of Example 21 is extruded at 165° C. into an annular die and blown into film. The film is homogeneous and has good mechanical properties.

### Example 32

The blend of Example 26 is extruded at 165° C. into an annular die and blown into film. The film is homogeneous and has good mechanical properties.

### Example 33

The blend of Example 27 is extruded at 200° C. into an annular die and blown into film. The film is homogeneous and has good mechanical properties.

### Example 34

The blend of Example 28 is extruded at 165° C. into an annular die and blown into film. The film is homogeneous and has good mechanical properties.

### Example 35

The blend of Example 29 is extruded at 200° C. into an annular die and blown into film. The film is homogeneous and has good mechanical properties.

TABLE 1

| Exam- | | 4G | TPA | DMT | Adi | DMAdi | Seb | DMSeb | | Comonomer | | Additive | TPT |
|---|---|---|---|---|---|---|---|---|---|---|---|---|---|
| ple # | 3G (g) | (g) | (g) | (g) | (g) | (g) | (g) | (g) | Comonomer ID | (g) | Additive ID | (g) | (g) |
| CE01 | 61.7 | | | 49.0 | | | 40.1 | | | | | | 0.059 |
| CE02 | 61.5 | | | 47.1 | | | 41.8 | | | | | | 0.059 |
| CE03 | 153.5 | | | 116.8 | | | 105.2 | | | | NaOAc—3H2O | 0.440 | 0.148 |
| CE04 | 153.2 | | 96.6 | | | | 108.6 | | | | | | 0.148 |
| CE05 | 61.1 | | | 43.3 | | | 45.1 | | | | | | 0.059 |
| CE06 | 60.7 | | | 39.6 | | | 48.4 | | | | | | 0.059 |
| CE07 | 150.0 | | | 83.0 | | | 135.1 | | | | | | 0.148 |
| CE08 | 63.7 | | | 46.9 | | | 33.9 | | Glu | 7.4 | | | 0.059 |
| CE09 | 63.2 | | | 46.6 | 8.1 | | 33.6 | | | | | | 0.059 |
| CE10 | 46.0 | | 30.3 | | | | 32.7 | | PTMEG 2900 | 2.8 | | | 0.059 |
| CE11 | 44.6 | | 30.8 | | | | 33.2 | | PTMEG 1000 | 23.8 | | | 0.059 |
| CE12 | | 68.5 | | 44.3 | | | | 44.7 | | | | | 0.059 |
| CE13 | | 77.5 | | 41.8 | | 45.8 | | | | | | | 0.059 |
| CE14 | 28100 | | | 23100 | | | 17400 | | | | NaOAc—3H2O | 81 | 27 |
| CE15 | 27800 | | | 20500 | | | 19700 | | | | NaOAc—3H2O | 81 | 27 |
| CE16 | 62.3 | | | 52.6 | | | 36.6 | | | | | | 0.059 |
| CE17 | | | | | | | | | | | | | |
| CE18 | 62.5 | | | 56.7 | | | 33.2 | | | | | | 0.059 |
| CE19 | 63.3 | | | 64.6 | | | 26.2 | | | | | | 0.059 |
| 1 | 63.1 | | | 44.7 | | | 28.0 | | PAnh | 13.7 | | | 0.059 |
| 2 | 62.9 | | 41.2 | | | | 29.7 | | PAnh | 9.5 | | | 0.059 |
| 3 | 62.5 | | | 46.1 | | | 33.2 | | PAnh | 8.1 | NaOAc—3H2O | 0.178 | 0.059 |
| 4 | 62.5 | | | 46.1 | | | 33.2 | | PAnh | 8.1 | | | 0.059 |
| 5 | 62.5 | | | 47.8 | | | 33.2 | | PAnh | 6.8 | NaOAc—3H2O | 0.178 | 0.059 |
| 6 | 62.1 | | | 40.5 | | | 36.7 | | PAnh | 9.4 | | | 0.059 |
| 7 | 62.1 | | 37.7 | | | | 36.7 | | PAnh | 6.7 | | | 0.059 |
| 8 | 62.1 | | 37.7 | | | | 36.7 | | PAnh | 6.7 | NaO2CH | 0.089 | 0.059 |
| 9 | 62.1 | | | 47.5 | | | 36.7 | | PAnh | 4.0 | | | 0.059 |
| 10 | 61.3 | | 34.2 | | | | 43.4 | | PAnh | 4.0 | | | 0.059 |
| 11 | 63.1 | | 38.3 | | | | 28.0 | | IPA | 15.3 | | | 0.059 |
| 12 | 62.9 | | | 48.2 | | | 29.7 | | IPA | 12.5 | | | 0.059 |
| 13 | 62.1 | | | 40.5 | | | 36.7 | | IPA | 10.5 | | | 0.059 |
| 14 | 62.1 | | 37.7 | | | | 36.7 | | IPA | 7.5 | | | 0.059 |
| 15 | 62.1 | | | 47.5 | | | 36.7 | | IPA | 4.5 | | | 0.059 |
| 16 | 61.3 | | | 40.0 | | | 43.4 | | IPA | 5.2 | | | 0.059 |
| 17 | 60.8 | | | 44.8 | | | 32.3 | | 1,8-NAnh | 10.6 | | | 0.059 |
| 18 | 60.7 | | | 43.0 | | | 35.9 | | 2,6-NDC | 10.8 | | | 0.059 |
| 19 | 59.5 | | | 43.9 | | | 31.6 | | 4,4′-OBBA | 13.5 | | | 0.059 |
| 20 | 60.0 | | | 44.2 | | | 31.9 | | 4,4′-BPDCA | 12.7 | | | 0.059 |
| 21 | | 69.6 | | 45.0 | | | | 35.6 | PAnh | 6.4 | | | 0.059 |
| 22 | | 76.8 | | 41.4 | | 37.1 | | | PAnh | 7.0 | | | 0.059 |
| 23 | 62.5 | | | 40.8 | | | 33.2 | | PAnh | 12.2 | | | 0.059 |
| 24 | 62.6 | | | 46.2 | | | 33.2 | | PAnh | 8.1 | | | 0.059 |
| 25 | 63.3 | | | 41.3 | | | 26.2 | | PAnh | 17.8 | | | 0.059 |

TABLE 2

| | IV | Tg | Tm | DAG | AVG Elm | Weight |
|---|---|---|---|---|---|---|
| Example # | (dL/g) | (° C.) | (° C.) | (mole %) | Tear (g/mm) | Loss (%) |
| CE01 | 1.54 | −21.3 | 142.7 | 0.32 | 4567 | |
| CE02 | 1.49 | −25.3 | 137.1 | 0.32 | 2402 | |
| CE03 | 1.85 | −24.8 | 131.5 | | 2774 | |
| CE04 | 1.60 | −26.5 | 130.1 | 0.62 | 3228 | |
| CE05 | 1.89 | −28.2 | 122.9 | 0.18 | 2190 | |
| CE06 | 1.93 | −34.1 | 102.9 | 0.16 | 1575 | |
| CE07 | 1.85 | −35.9 | 80.2 | 0.14 | 1031 | |
| CE08 | 1.80 | −23.2 | 129.8 | 1.66 | 2683 | |
| CE09 | 1.48 | −24.6 | 131.5 | 0.16 | 2814 | |
| CE10 | 1.17 | −43.8 | 132.7 | | 2243 | |
| CE11 | 1.04 | −59.7 | 120.8 | 6.68 | 2012 | |
| CE12 | 1.90 | −28.4 | 128.5 | 0.04 | 15866 | |
| CE13 | 1.32 | −28.5 | 122.5 | | 12256 | |
| CE14 | 1.14 | −18.5 | 148.0 | 0.46 | | 2.0 |
| CE15 | 1.25 | −27.3 | 132.2 | 0.44 | | 2.3 |
| CE16 | 1.51 | −22.0 | 150.0 | 0.3 | 4879 | 3.1 |
| CE17 | | | | | | 1.8 |
| CE18 | 1.61 | −15.8 | 159.8 | 0.14 | 3086 | 2.3 |
| CE19 | 1.28 | −2.3 | 180.4 | 0.46 | 1021 | 1.8 |
| 1 | 1.49 | −7.6 | 117.9 | 0.54 | 12598 | |
| 2 | 1.68 | −6.9 | 131.4 | 1.3 | 16496 | |
| 3 | 1.80 | −10.9 | 129.0 | 0.36 | 10551 | |
| 4 | 1.58 | −13.2 | 123.0 | 0.36 | 12244 | |
| 5 | 1.59 | −12.7 | 132.0 | 0.42 | 9217 | |
| 6 | 1.61 | −18.4 | 104.4 | 0.4 | 4882 | |
| 7 | 1.78 | −16.3 | 118.8 | 1.04 | 5114 | |
| 8 | 1.76 | −16.3 | 119.4 | 0.74 | 5568 | |
| 9 | 1.71 | −19.1 | 129.1 | 0.4 | 5079 | |
| 10 | 1.96 | −23.2 | 105.9 | 0.6 | 3071 | |
| 11 | 1.17 | −3.1 | 123.9 | 0.76 | 4661 | |
| 12 | 1.63 | −5.0 | 132.2 | 0.26 | 10000 | |
| 13 | 1.61 | −15.1 | 110.1 | 0.28 | 4921 | |
| 14 | 1.43 | −15.9 | 119.6 | 0.92 | 5122 | |
| 15 | 1.64 | −16.3 | 129.3 | 0.38 | 7362 | |
| 16 | 1.96 | −24.6 | 106.1 | 0.2 | 2126 | |
| 17 | 1.56 | −16.5 | 147.5 | 0.34 | 6648 | |
| 18 | 1.47 | −11.5 | 130.2 | 0.3 | 6929 | |
| 19 | 1.51 | −6.0 | 126.4 | 0.3 | 9745 | |
| 20 | 1.48 | −4.2 | 133.8 | 0.38 | 6938 | |
| 21 | 1.56 | −21.0 | 134.7 | 0.18 | 23750 | |
| 22 | 1.47 | −21.9 | 116.9 | | 16396 | |
| 23 | 1.45 | −19.8 | 112.5 | 0.44 | 9055 | 4.8 |
| 24 | 1.42 | −19.1 | 124.1 | 0.44 | 11220 | 2.5 |
| 25 | 1.28 | −7.1 | 126.8 | 0.62 | 19331 | 5.4 |

What is claimed is:

1. An aliphatic-aromatic copolyester consisting essentially of:
I. a dicarboxylic acid component consisting essentially of, based on 100 mole percent total acid component:
a. about 40 to 80 mole percent of a first aromatic dicarboxylic acid component consisting essentially of a terephthalic acid component; and
b. about 60 to 10 mole percent of a linear aliphatic dicarboxylic acid component; and
c. about 2 to 30 mole percent of a second aromatic dicarboxylic acid component; and
II. a glycol component consisting essentially of, based on 100 mole percent total glycol component:
a. about 100 to 96 mole percent of a linear glycol component; and
b. about 0 to 4 mole percent of a dialkylene glycol component.

2. The aliphatic-aromatic copolyester of claim 1 wherein the copolyester is semicrystalline.

3. The aliphatic-aromatic copolyester of claim 1 wherein the copolyester is biodegradable as defined according to EN 13432.

4. The aliphatic-aromatic copolyester of claim 1 wherein the linear glycol component is selected from the group consisting of 1,2-ethanediol, 1,3-propanediol, and 1,4-butanediol.

5. The aliphatic-aromatic copolyester of claim 1 wherein the linear aliphatic dicarboxylic acid component is selected from the group consisting of azelaic acid, sebacic acid, and brassylic acid.

6. The aliphatic-aromatic copolyester of claim 1, wherein the second aromatic dicarboxylic acid component is selected from the group consisting of phthalic anhydride, phthalic acid, and isophthalic acid.

7. The aliphatic-aromatic copolyester of claim 1 wherein the dicarboxylic acid component consists essentially of, based on 100 mole percent total acid component:
a. about 46 to 69 mole percent of a first aromatic dicarboxylic acid component consisting essentially of a terephthalic acid component; and
b. about 49 to 26 mole percent of a linear aliphatic dicarboxylic acid component; and
c. about 4 to 19 mole percent of a second aromatic dicarboxylic acid component.

8. The aliphatic-aromatic copolyester of claim 1 wherein the dicarboxylic acid component consists essentially of, based on 100 mole percent total acid component:
a. about 51 to 59 mole percent of a first aromatic dicarboxylic acid component consisting essentially of a terephthalic acid component; and
b. about 44 to 34 mole percent of a linear aliphatic dicarboxylic acid component; and
c. about 6 to 14 mole percent of a second aromatic dicarboxylic acid component.

9. The aliphatic-aromatic copolyester of claim 1, wherein the total aromatic content is greater than 61 mole % based on 100 mole % of total acid component.

10. The aliphatic-aromatic copolyester of claim 1, wherein the polymer does not contain a sulfur atom or a phosphorus atom.

11. A blend comprising the aliphatic-aromatic copolyester of claim 1 and at least one other polymeric material.

12. The blend of claim 11 wherein said other polymeric material is selected from the group consisting of a natural polymer, starch, and poly(lactic acid).

13. A shaped article comprising the aliphatic-aromatic copolyester of claim 1.

14. A shaped article comprising the blend of claim 11.

15. A film comprising the aliphatic-aromatic copolyester of claim 1.

16. A film comprising the blend of claim 11.

17. The film of claim 15 with tear strength greater than about 5000 g/mm according to ASTM D1922.

18. The film of claim 15 with tear strength greater than about 8000 g/mm according to ASTM D1922.

19. The film of claim 15 with tear strength greater than about 16000 g/mm according to ASTM D1922.
